(19) United States
(12) Patent Application Publication
(10) Pub. No.: US 2025/0182723 A1
(43) Pub. Date: Jun. 5, 2025

(54) SUPPORTING STRUCTURE FOR USE IN A PERCUSSION MUSICAL INSTRUMENT

(71) Applicant: Oleg Vasilyevich ZHILIN, Moscow (RU)

(72) Inventors: Oleg Vasilyevich ZHILIN, Moscow (RU); Mikhail Gennadievich KAMENEV, Vladivostok (RU)

(73) Assignee: Oleg Vasilyevich ZHILIN, Moscow (RU)

(21) Appl. No.: 18/842,787

(22) PCT Filed: Aug. 25, 2022
(86) PCT No.: PCT/RU2022/000259

§ 371 Date: Aug. 29, 2024

(30) Foreign Application Priority Data
Mar. 5, 2022 (RU) 2022105872

(51) Int. Cl. G10D 13/10

(52) U.S. Cl. CPC G10D 13/10

(57) ABSTRACT

Provided are percussion musical instruments and details therefor, and more particularly a supporting structure for a sonorous element of a xylophone-type instrument and an instrument in which said supporting structure is used. They can be used in the construction of percussion musical instruments that produce music using sound generated by the vibration of a sonorous element. The present supporting structure is made from resilient elastic materials shaped to form a cylinder, the ends of which are provided with annular protuberances having mutually facing conical protuberances, the tips of which are separated by a distance determined by the width of the sonorous element. The supporting structure simultaneously performs the functions of a support and a damper in a musical instrument. The technical result is that of broadening the range of supporting structures for use in percussion musical instruments, which provide for reduced mechanical impact on the vibration of a sonorous element and, thus, improved sound quality, while also simplifying the structure of musical instruments in which the claimed damping support is used.

### CROSS-REFERENCE TO RELATED APPLICATIONS

The application claims priority to Russian patent application No. 2022105872, filed on Mar. 5, 2022, the entire contents of which are incorporated herein by reference.

### TECHNICAL FIELD

This invention relates to percussion musical instruments and details therefor, specifically, to a supporting structure for a sonorous element in musical instruments such as xylophones or glockenspiels. It can be used, inter alia, in the designs of new types of percussion instruments that reproduce music using sound generated by the vibration of the sonorous element.

### BACKGROUND

The traditional design of percussion musical instrument includes a frame that holds the elements producing harmonic sounds, usually in form of plates equipped with two holes, bars, hollow tubes and other possible types. The width of each element is usually standard, and the length varies depending upon the desired pitch level. The elements are mounted on a substrate made from a shock-absorbing material (most often foam plastic) and fixed to a frame or housing using a support pin. The sound largely depends on the material of the sonorous element-woods, metals or plastics (fiberglass, kelon, clipron, etc.). Musical toys such as a xylophone have a simplified design, in which the sonorous element is fixed using a pin in form of nail/screw or stud, sometimes placed in soft rubber or PVC sleeve. In upper part such pin is usually equipped with disc-shaped flange made from the same material and a cap. However, due to the large contact surface between the shock-absorbing substrate and the sonorous element, this design provides low sound quality.

Several solutions have been developed to reduce such effects. One such solution is a damping system to be intended to reduce the contact area with shock-absorbing substrate by its pointed protuberances positioned on its surface and the sonorous element fixed to body support through an opening equipped with shock-absorbing insert (Patent Application KR No. 850004226U). This minimizes the contact area between the underside of the sonorous element and the damping system which increases plate impact sensitivity and additionally extends the sound duration, thereby improving the overall sound quality.

A known supporting structure used for the sonorous element of xylophones/glockenspiels which utilizes a vertical support for xylophone body, on top of which an elastic quadrangle is glue-installed, with one of its edges being in contact with lower surface of plate. Both surfaces are also pin-secured (Patent Application KR No. 2029959924498).

Known designs of supporting element for percussion instruments include a vertical support that is located on instrument body and consists of two parts. One part of this support is intended to fix the upper surface of the sonorous element, such as by using a screw passing through a hole in the sonorous element and its glued elastic flange. The second part of the support has a shock-absorbing pad made from a polymer material, which has a longitudinal section in the shape of tetrahedron. One its edge is in contact with bottom surface of the sonorous element, while its opposite edge is embedded in vertical support on the body. In order to reduce the material consumption, it has been proposed to provide the second part of body support with open-end hole that has an upward-sloping upper section. This allows to install the opposite edge of shock-absorbing insert (Patent Application KR No. 19990039021U). Elastic structural elements are additionally installed to improve the shock-absorption of the plate.

Similar solutions have also been proposed, for example, in several other applications from South Korea. In these applications, the upper surface of plate is also fixed with pin (nail) that passing through the shock-absorbing insert in the hole of the sonorous element and body support. The lower surface of the plate rests on sharp edge of shock-absorbing quadrangle, e.g. in Patent Application KR No. 200453685.

Thus, all the listed technical solutions for the supporting structure are intended to reduce the directly contact area between the sonorous element and the support of instrument body, which, in turn, leads to plate vibration failure and dull sound, thus reducing the overall sound quality due to vibration of musical instrument body.

In addition, it should be noted that the manufacture of such systems and musical instruments with them is a labour-intensive process.

### SUMMARY

There is a known elastic supporting structure made from an elastic material for a sonorous element and a musical instrument using it, in which the supporting structure is made in the form of a cylinder with a longitudinal through hole equipped with an annular protuberance at the upper end. This design is installed either on the body frame of a musical instrument or on a vertical support of the body frame, fixing the sonorous element with a pin and performing a shock-absorbing function in the instrument (Patent Application KR No. 830002455Y1). However, the use of such a supporting structure does not provide adequate sound purity, since when used as part of a musical instrument body, noise interference from shaking the body and various connecting parts is inevitable. This solution is considered as the closest to the claimed one, but problems associated with reducing vibration disturbances of the plate itself and the appearance of a dull sound that reduces sound quality due to vibration of the body of the musical instrument remain.

The proposed solution to the problems includes a new support design for the sonorous element and a percussion musical instrument using it.

The inventive supporting structure for sonorous element of percussion instrument is a cylinder made from elastic material. At the ends of this cylinder, there are annular protuberances. The inner surfaces facing a cylinder are supplied with two cone-shaped protuberances.

The problems are also solved by a percussion instrument of a xylophone type. It consists of a sonorous element with two holes at ends. The sonorous element is supported by an elastic cylinder, which has two annular protuberances at its ends, on each inner surface facing the cylinder there are two cone-shaped protuberances, and tips of an upper cone-shaped protuberance and a lower cone-shaped protuberance are separated by a distance. These create vibrations that are transmitted to the sonorous element. A lower annular protuberance has a cavity that contains a weighting element.

The technical result of these solutions includes an expansion of range of the supporting structures for the sonorous element of the percussion instrument. These structures simultaneously perform functions of supporting the sonorous element and acting as a shock absorber when in use. They are versatile, easy to manufacture and use. This design also allows to create the percussion musical instruments that have an increased sound quality due to reduction of extraneous vibrations of the sonorous element caused by the mechanical action of the support and due to minimization of contact area between the sonorous element and the supporting structure, which also helps to reduce any unwanted vibrations. Additionally, this design allows to reach the consistent sound quality even when the instrument is placed in different positions, due to the symmetrical cylinder construction relative to both the horizontal and vertical axes.

### BRIEF DESCRIPTION OF DRAWINGS

FIG. 1 shows a general view of the proposed supporting structure, where 1 represents a cylindrical body, 2 represents annular protuberances, and 3 represents cone-shaped protuberances.

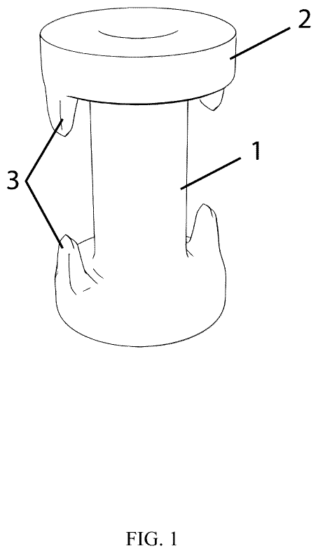

FIG. 2 illustrates a possible example of the supporting structure, where 4 represents a vertical hole, 5 represents a base cavity, and 6 represents a weighting element.

FIG. 3 illustrates a possible example to use the supporting structure for a sonorous element in a percussion musical instrument, such as a plate (a) or a hollow tube (b), where 7 represents the sonorous element, 8 represents holes in the sonorous element and 9 represents the supporting structure.

FIGS. 4 (c) and (d) illustrate a possible example to install the percussion musical instrument using the supporting structure.

FIG. 5 illustrates a possible example of composite musical instruments.

### DETAILED DESCRIPTION OF THE EMBODIMENTS

The innovative design of the support element, made from an elastic material with annular protuberances that touching a sonorous element surface with cone-shaped protuberances, can significantly reduce the contact area between the support element and the sonorous element, thereby reducing the impact of vibrations on the sonorous element. This design is easy to be manufactured and can be attached to instrument sonorous element, making it suitable for use as a support for percussion instruments, such as the xylophone, in various combinations.

The supporting structure (9) can be manufactured by casting or turning. The annular protuberances are removable, making it easy to install the sonorous elements later. The supporting structure can be made from elastic materials, such as a resin, a rubber, a silicone, polymers or others, providing the sonorous element vibration damping and absorbing the shocks and impacts.

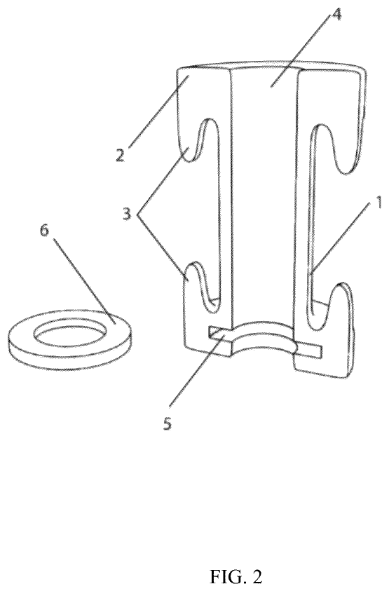

The support (FIG. 2) can be made with a vertical hole (4), which allows it to be integrated into the support base with studs. This makes it suitable for both independent musical instruments and as a shock-absorbing part in other percussion instruments, such as xylophones, glockenspiels, or metallophones. When placed on a stud, which can be made in the form of, e.g., a screw or a bolt, on top the support can be secured with a cap or other fastening element.

The lower annular protuberance of the support can be provided with a cavity (5), which can be used to install a weighting element (6), if necessary. The weighting element could be in the form of, e.g., a metal or a magnetic annular. This would extend the possibilities to use such support in various installation options of percussive instruments, without need for additional supporting structures.

The dimensions of annular and cone-shaped protuberances on a musical instruments vary and are dependent on the conditions under which the instruments were made.

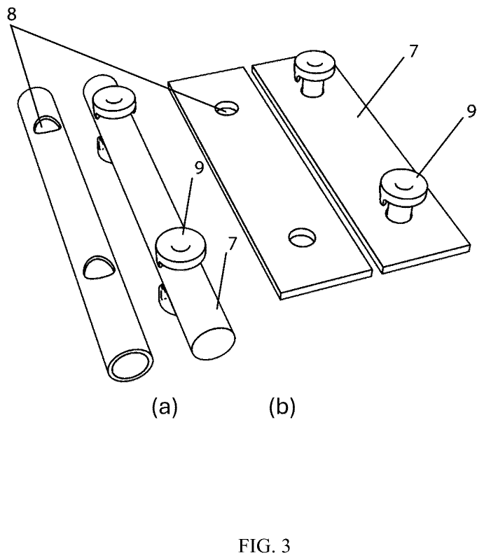

The support is inserted into the holes (8) of the sonorous element (7) with one of its bases, forming a musical instrument. This allows to install the sonorous elements in various shapes, such as plates (a), hollow tubes (b) or bars (FIG. 3). These sonorous elements can be made from materials emitting the harmonic vibrations when struck, such as woods, metals or plastics (fiberglass, kelon, kliperon, etc.).

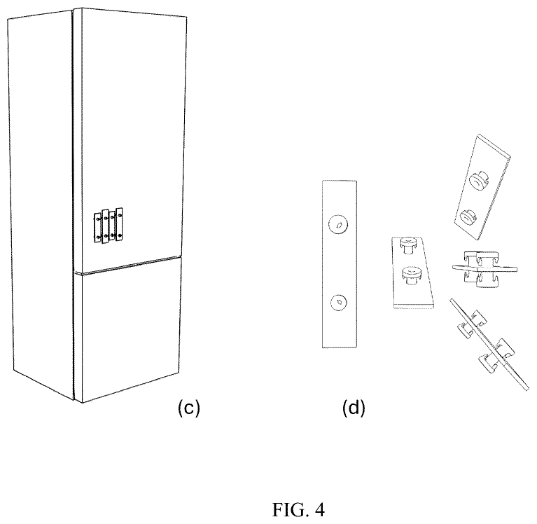

The proposed percussion musical instrument with the sonorous element placed in the inner contour of the shock-absorbing support and the elastic properties of the entire support having a symmetrical arrangement and providing the almost point-to-point contact on both sides of the sonorous element, allows to keep the purity of sound vibrations for the installed element in various spatially-oriented positions and on different surfaces (FIG. 3). For example, the ferromagnetic weighting element enables to install the instrument at different angles on metal surfaces and even in a horizontal inverted plane, while preserving its properties (FIG. 4).

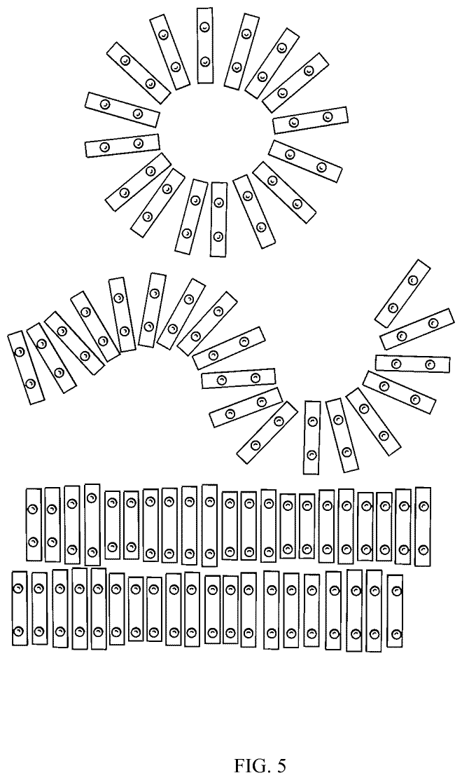

The proposed percussion musical instrument is easy to be produced and used, even for children. It has maximum compactness and good sound as well as the ability to quickly assemble any complex melodic sequence from a set of such instruments, and provides the greatest opportunities for creativity (FIG. 5)

What is claimed is:

1. A supporting structure for a sonorous element of a percussion instrument, wherein the supporting structure is made from an elastic material and in shape of a cylinder, ends of the cylinder are equipped with two annular protuberances, and an inner surface of each of the two annular protuberances faces the cylinder and has two cone-shaped protuberances.

2. The supporting structure according to claim 1, wherein a rubber or a silicone or a resin is used as the elastic material of the supporting structure.

3. The supporting structure according to claim 1, wherein the supporting structure has a vertical hole.

4. The supporting structure according to claim 1, wherein the two annular protuberances are removable.

5. The supporting structure according to claim 1, wherein a lower annular protuberance among the two annular protuberances has a cavity.

6. A percussion musical instrument of a xylophone type, comprising a sonorous element with two holes at ends and a supporting structure made from an elastic material, wherein the supporting structure is in shape of a cylinder, each of ends of the cylinder has an annular protuberance, an inner surface of each annular protuberance faces the cylinder and has two cone-shaped protuberances, tips of an upper cone-shaped protuberance and a lower cone-shaped protuberance are separated by a distance, providing a vibration of the sonorous element, and a lower annular protuberance has a cavity that contains a weighting element.

7. The percussion musical instrument according to claim 6, wherein the sonorous element is a plate or a tube or a bar.

8. The percussion musical instrument according to claim 7, wherein the sonorous element is made from a wood or a metal.

9. The percussion musical instrument according to claim 6, wherein the weighting element is a ferromagnet.

10. The percussion musical instrument according to claim 6, wherein the supporting structure has a vertical hole.

11. The percussion musical instrument according to claim 6, wherein the supporting structure is made from a rubber, a silicone or a resin.
